(19) United States
(12) Patent Application Publication
(10) Pub. No.: US 2013/0006745 A1
(43) Pub. Date: Jan. 3, 2013

(54) SYSTEM & METHOD FOR PROVIDING INSTANT TANGIBLE REWARDS AT AUTOMATED DEVICES

(76) Inventor: Craig K. Potts, Scottsdale, AZ (US)

(21) Appl. No.: 13/538,656

(22) Filed: Jun. 29, 2012

Related U.S. Application Data
(60) Provisional application No. 61/503,849, filed on Jul. 1, 2011.

(51) Int. Cl. G06Q 30/02

(52) U.S. Cl. 705/14.27

(57) ABSTRACT

An incentive system is provided which includes the coordinated operation of at least one automated customer service device, an incentives program management system and a tangible reward awarding device, wherein a user is automatically awarded a tangible award if certain criteria or activity is carried out and identified by the incentives program system. Through appropriate communication, the incentives program management system can identify predetermined user activities or criteria based upon a user's interaction with an automated customers service device, and then trigger a tangible reward device to award a predetermined tangible award to the user. In this manner, tangible rewards can be awarded to users at a location having the automated customer service device and an associates reward device without the need for interaction by an employee.

### FIELD OF THE INVENTION

The present invention relates to incentives or rewards surrounding various customer contact situations. More particularly, the present invention relates to systems and methods for providing bonuses, rewards and other incentives, in connection with cash access services, automated purchasing and other electronic sales situations to promote customer loyalty and control promotional expenses.

### BACKGROUND OF THE INVENTION

Modern consumers have begun to carry less cash and use debit cards, credit cards and other forms of non-cash payments more frequently in order to pay for goods and services. In many cases, consumers now use these tools to make purchases using automated check-out systems. Additionally, Automated Teller Machines (ATMs) have become hugely popular and a primary source of banking transactions. In certain industries or situations, such as the entertainment/recreation industry, consumer access to cash is critical to the success of the business. Allowing consumers to access their money whenever and however they want puts more money in play in these situations (e.g. casinos, sporting events, race tracks, vacation spots, etc.).

In today's market place, numerous systems are used for completing and/or assisting automated transactions with increasing sophistication. These systems may include self-checkout registers, automated kiosks, vending machines, automated ticket counters, etc. Other systems may be supporting in nature, such as loyalty tracking systems. For example, systems commonly used in a casino to manage slot machines (“Slot Management Systems”) or to track a casino patron's play and award incentives (“Casino Patron Management Systems”) have evolved considerably. These systems provide data communication interfaces which facilitate extensive interoperability between the system, the slot machines and the patron playing the slot machine. In addition to the example above, ATM systems typically include a very complex communication methodology to insure security and speed. As these systems evolve, it will be possible to provide limited communication with other systems, thus providing for additional features.

While automated systems exist to provide consumers with easier access to products, entertainment or cash, merchants can further improve profitability, lower costs and expenses per transaction, and achieve greater customer loyalty by providing incentives and bonuses in connection with these automated systems.

### BRIEF SUMMARY OF THE INVENTION

Consumers can be rewarded for their loyalty and/or use of automated devices by providing instant prizes or awards in certain situations. Automated devices come in a variety of forms, including automated teller machines (“ATM”), self-checkout registers, kiosks, automated ticket machines, vending machines, movie dispensers, etc. Based upon predetermined and configurable criteria, a user of the automated device is selected to receive an award. In certain embodiments, these are physical product awards. Organizations managing or controlling the automated device has full control over how award recipients are selected. Further, a large array of selection criteria can be customized to each property, industry or device, as desired.

### BRIEF DESCRIPTION OF THE DRAWINGS

FIG. 1 is a schematic representation of an exemplary embodiment of a system and method for providing rewards and incentives in connection with automated devices.

FIG. 2 is a schematic representation of a reward system implemented at a retail outlet.

FIG. 3 is a network diagram showing the implementation of the present system at multiple locations.

FIG. 4 illustrates the implementation of the present system using the internet.

FIG. 5 is a perspective view of an automated prize rewarding device.

### DETAILED DESCRIPTION OF VARIOUS EMBODIMENTS

Various embodiments of the invention are described hereinafter with reference to the figures. It should also be noted that the figures are only intended to facilitate the description of various embodiments of the invention. The embodiments are not intended as an exhaustive description of the invention or as a limitation on the scope of the invention. In addition, an aspect described in conjunction with a particular embodiment of the invention is not necessarily limited to that embodiment and can be practiced in any other embodiment or variation of the invention.

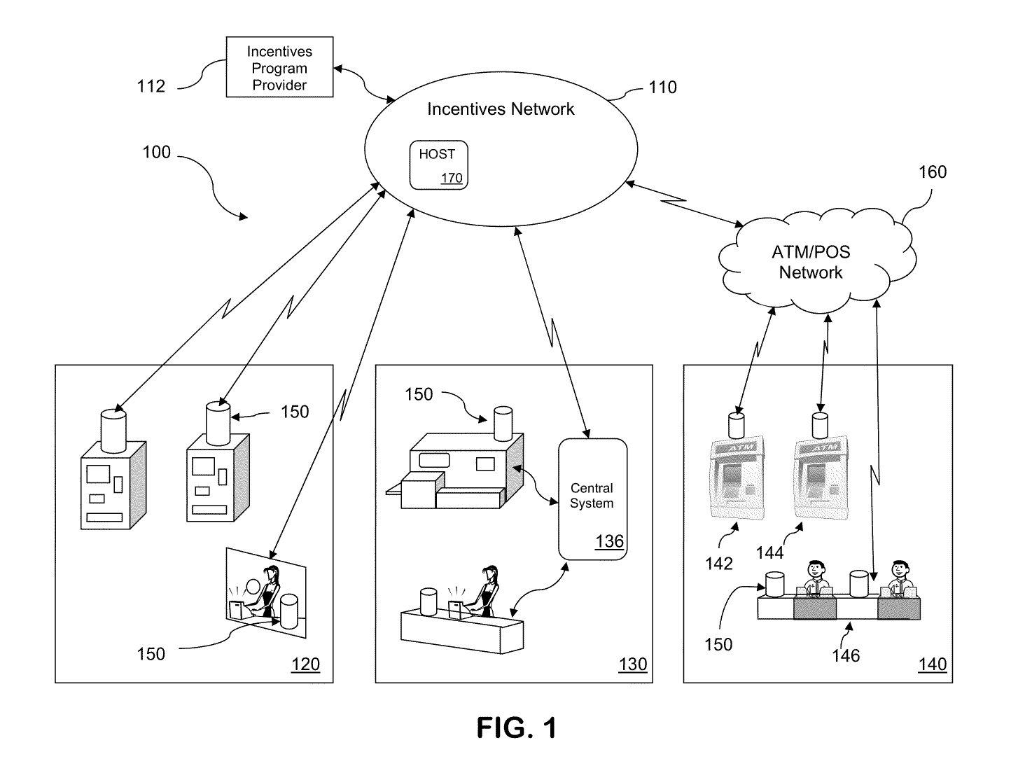

Referring to FIG. 1, an embodiment of an incentives system 100 is generally illustrated. In this particular embodiment, an overall incentives network 110 is in communication with numerous components and other related devices. This network 110 will include various processors and/or servers to carry out the incentives program and to provide appropriate communication to all necessary devices. The incentives network 110 may be established and managed by an incentives program provider 112. The overall incentives system 100, as embodied in FIG. 1, may include many different retail outlets. As will be further described below, each of these retail outlets provides different mechanisms for customer interaction and each interaction potentially gives a customer a chance of participation in the incentives program. More particularly, this illustrated embodiment includes incentives system 100 operating in conjunction with a box office 120, a retail store 130 and a bank 140. In each retail outlet 120, 130, 140, a rewards device 150 is physically provided at a location of customer interaction using electronic and automated customer service devices. Obviously, these automated customer services devices can take on many different forms, but each generally involves some type of interaction with a user or customer. The details of the rewards device 150 will be described in further detail below.

Turning to the first implementation of incentives system 100, the box office 120 could be a box office for a typical movie theater, sporting events, amusement parks, concert venues or any other similar retail outlet configured for ticket sales. In this particular embodiment, box office 120 includes a plurality of automated ticket machines 122, 124 and a ticket sales window 126. At each particular location, a rewards device 150 is similarly coupled to each of these ticket sales devices. Utilizing the concepts outlined below, the incentives system 100 of the present invention can thus carry out a desired incentives program.

As mentioned, incentives system 100, as illustrated in FIG. 1, also incorporates a retail establishment or retail store 130. In this particular case, a self-checkout terminal 132 and a standard checkout lane 134 are illustrated. As will be recognized, self-checkout terminal 132 will typically contain a display screen and appropriate optical scanning devices to scan products being purchased. Also in a well known manner, standard checkout lane 134 will include similar components that are designed for use by a cashier. In this particular embodiment, each of these components includes a rewards device 150 and communicates with a central system 136 to coordinate sales and retail transactions. The central system 136 in turn communicates with the incentives network 110 to carryout the incentives program of the present invention.

In addition, FIG. 1 illustrates a bank 140 that includes a plurality of ATMs 142, 144 and a plurality of tellers behind a counter 146. In each case, a rewards device 150 is coupled to each of these particular locations. More specifically, a rewards device 150 is physically positioned above the first and second ATMs 142, 144 and at counter 146, either one per teller (as shown) or one per counter. As is generally understood, each ATM 142, 144 communicates with an ATM or POS (Point of Service) network 130 in a well known manner. As appreciated by those skilled in the art, this communication requires several levels of security and coding to ensure efficient operation. Consequently, communication with this system 160 is often difficult. However, the incentives network 110 of the present invention is configured to provide an exclusive communication link with ATM network 160, consequently providing a controlled and very limited access point.

Also illustrated in FIG. 1 is a Host Processor 170, which in this embodiment is understood to be part of the incentives network 110. Host Processor 170 stores and utilizes the incentives program software to determine the selection of reward recipients, the frequency of the rewards and amount or type of the rewards. Host Processor 170 also provides the ability to coordinate instant on-site rewards at the time of the transaction to patrons at the box office 120, retail store 130 and bank 140, as well as users of the ATMs 142, 144 and/or automated ticket machines 122, 124.

Rewards may also be delivered or redeemed via the bank 140, retail store 130 or box office 120, or via a web site supported by the retail outlet companies or incentives network provider 112. Utilizing the reward information stored and updated at Host Processor 170, the information can be communicated via the incentives network 110, such as through the Internet or World Wide Web, and delivered to the patron's web browser on a web site supported by the retail outlet companies and/or incentives network provider 112. Patrons will be given the appropriate information to redeem their rewards. In addition, or alternatively, incentives program provider 112 may provide the rewards via home or business delivery, e.g., by the U.S. postal service, FedEx®, UPS®, etc., or via an electronic distribution method, such as an e-mail sent to the patron's e-mail inbox.

It should be understood that the various devices could communicate with the incentives network 110 via any type of communication methodology, including both wired or wireless connections. It is possible that a wireless/web-enabled device can be used interchangeably and represent any device or device types mentioned above, including POS devices, ATM terminals, specific terminals, smart phones, PDAs, mobile phones, award kiosks and booths, web sites or any web capable device. It should also be understood that the illustrations shown are not meant to be illustrative of an actual configuration for a computer network, but is merely an idealized schematic representation employed to more clearly and fully depict the invention.

Referring again to FIG. 1, connection between customer interaction devices and the incentives network 110 may be accomplished in various ways. As illustrated with respect to the box office 120, each individual customer interaction device, in particular automated ticket machines 122, 124 and ticket window 126, are connected directly to the incentives network 110. The retail store 130, however, illustrates the connection of the different devices, such as the self-checkout machine 132 and the standard checkout lane 134, to a central storewide system, which in turn is connected to the incentives network 110. As for the bank 140, the individual ATMs 142, 144 and the teller locations 146 connect to a more extensive and external ATM/POS network 160 for security reasons. This overall secured network 160 is then connected by a highly secure and controlled connection to the incentives network 110. It should be understood that variations, combinations and other alternative configurations of these connections are contemplated and within the scope of the present invention.

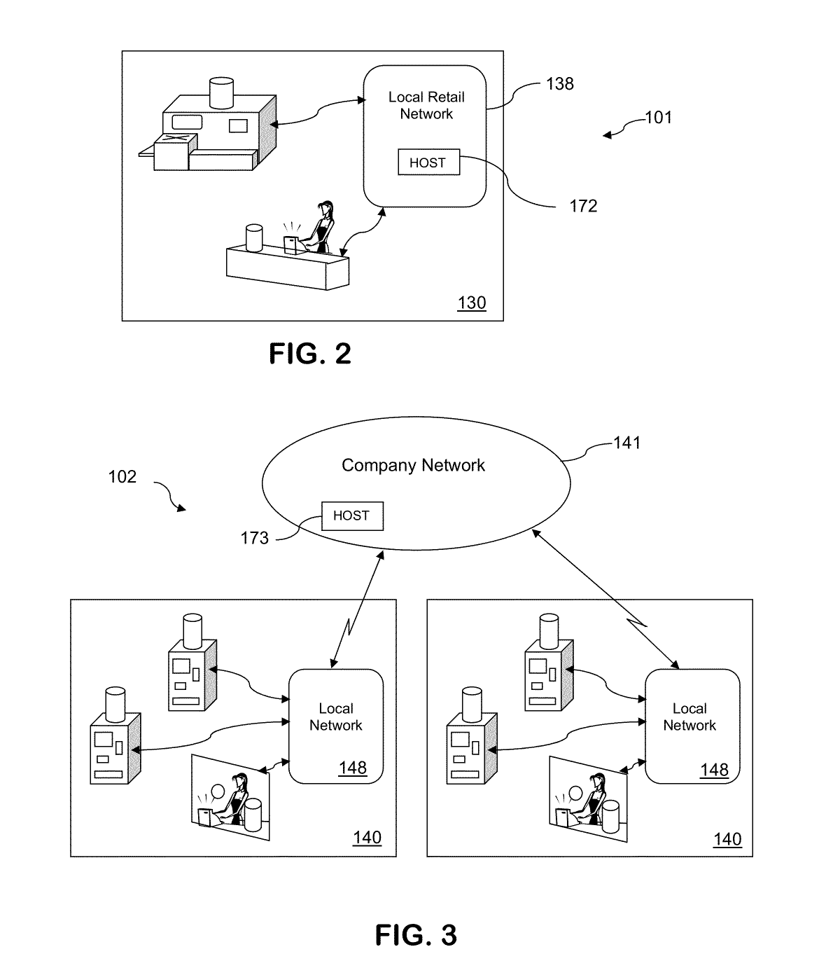

Referring now to FIG. 2, another embodiment of the incentives system 101, in accordance with the present invention, is illustrated with the retail store 130. In this embodiment, the host processor 172 is provided for a smaller system and is included as part of the local retail network 138. In this situation, each customer interaction device, such as self-checkout terminal 132 or the standard checkout lane 134, is connected to the retail store's local network 138. These connections 133, 135, respectively, provide the necessary data for the host processor 172 to implement the incentives program and distribute the rewards from the rewards devices 150 to various customers.

In FIG. 3, a further embodiment of the incentives system 102, in accordance with the present invention, is illustrated with the box office 140. In this embodiment, a number of box offices 140, each having one or more ticket buying devices 142, 144, 146 and a local network 148, are connected to an external, overall company network 141. In addition, a host processor 173 is provided as part of the company network 141, thereby being able to manage a company-wide incentives program. Although the incentives program is external to each retail location 140, it is still implemented within the individual company.

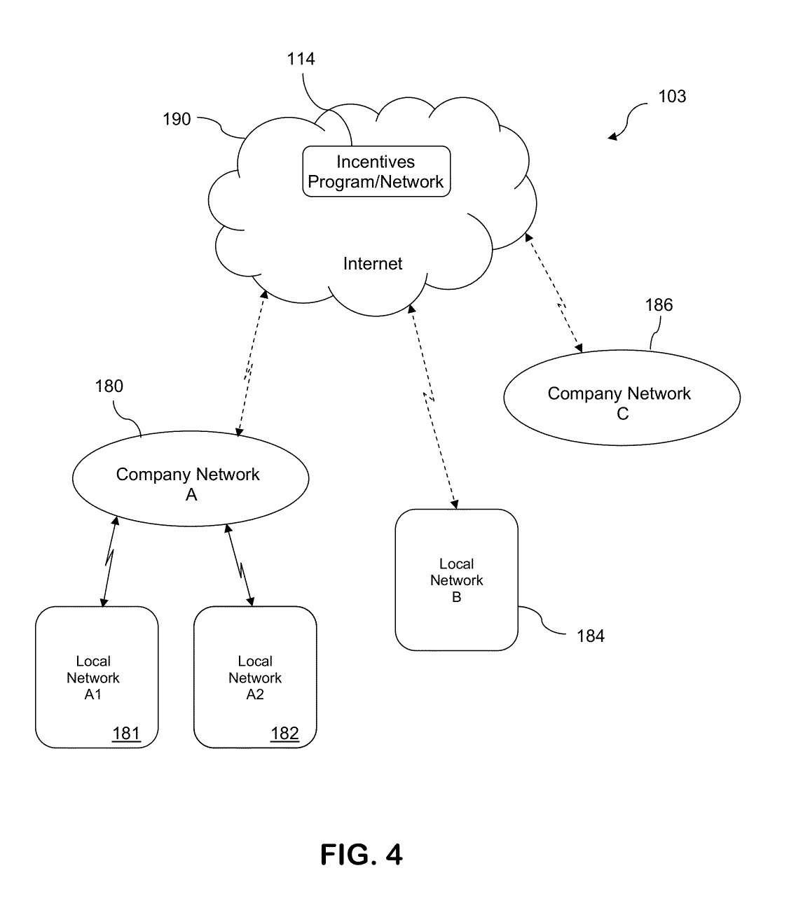

Referring now to FIG. 4, yet another embodiment of an incentives system 103, in accordance with the present invention, is illustrated with the incentives program/network 114 implemented out on the Internet 190. In this embodiment, the incentives program 114 supports many different companies, including multi-layer companies 180 having one or more subsidiaries or local retail locations 181, 182, less complex local retail locations 184 and/or other types of companies 186. In each of these cases, the company 180, 184, 186, accesses and interfaces with the incentives program 114 via appropriate and known Internet connections (as illustrated by dashed lines). In this way, the incentives program 114 is capable of supporting a large number and various different types of clients, each having its own particular criteria and desired implementation of the incentives program 114.

As one example, the incentives program may be organized and managed in a similar manner as other such programs, see for example, US Patent Pub. No. 2007/0087817 A1, entitled SYSTEM AND METHOD FOR CASH ACCESS SERVICES BONUSING AND INCENTIVES, published Apr. 19, 2007, incorporated herein by reference in its entirety.

As will be recognized, the incentives program carried out by the incentives network 110 can take many forms, depending on the desires of the incentives program provider 112. Certain examples may include random drawings based upon predetermined transactions, selection upon completion of predetermined customer activities, or random selection of customers in a predetermined customer base. Coordination of these various incentive programs is made possible through the networking methodologies outlined above. In the embodiments illustrated, the various networks (i.e. incentives network 110, local retail network 138, company network 141 or incentives Program/network 114) will include the necessary elements to administer and carry out these programs, which all provide the ability to award tangible awards at the point of customer contact.

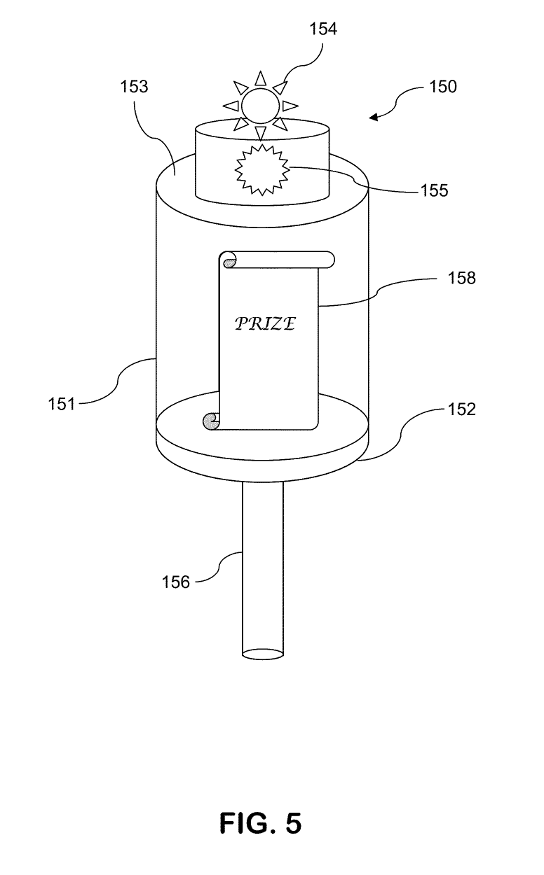

Referring now to FIG. 5, a representation of a rewards device 150 is illustrated, in accordance with the present invention. The rewards device 150 includes an enclosed container 151, typically having a bottom 152 and a top 153. A reward 158 is housed Inside of the container 151. The rewards container 151 will be configured for display, in order to highlight the reward 158 and entice the customer to participate in the incentives program by taking an action specified by the program. In some cases, the rewards container 151 may include a means 154 for alerting the customer and others in the area that the customer has met the designated criteria and thereby won the reward 158. The alerting means 154 may include a light, which may be flashing, rotating or steady, a sound source 155, or both. The rewards container 151 may be mounted on an existing structure, as shown in FIGS. 1-3, or it may be mounted on its own support 156 and located at or in proximity to the point of customer interaction.

In most cases, the container 151 will be locked electronically and configured to dispense the reward 158 when a customer wins. In one embodiment, dispensing of the reward 158 may include opening of the container 151 so that the customer can reach in and take the reward 158. In this situation, management of the retail location would then need to reload the rewards device 150, so that another customer could win another reward 158. Alternatively, dispensing may include ejection of the reward 158 from the container 151 into a cup, holder or other open or closed chamber that allows the customer can take it, in a manner similar to vending machines. Optionally, instead of the reward 158 itself, a token or other item redeemable for the reward 158 may be dispensed by the rewards device 150.

In some cases, the container 151 would not open upon a win by a customer, but instead the retail management would provide the customer with the tangible reward 158 or a tangible representation of an intangible reward, such as store credit, free electronic tickets, bonus credit card reward points, etc. For the most part, however, the incentives system 100 of the present invention is geared toward tangible rewards that may be displayed at the customer interaction point in a manner that draws in customers, giving them obvious incentive to participate in the current promotion. Depending on the type of retail location and monetary level of the promotion, the reward 158 may be high-end electronic devices, (i.e., cellular phones, iPods®, iPhones®, tablets, laptop computers, etc.), it may be keys to a new car represented by a model of the car, it may be airline, concert or sports tickets, or any other currently desirable item. One example of a rewards device design is the BonusBox® by Gaming Support in The Netherlands, or its US company, Gaming Support USA, Inc., in Las Vegas, Nev. The BonusBox® is marketed and sold to the gaming industry, such as casinos, for use with slot machines and other games.

Whichever reward 158 is provided in the rewards device 150 or whatever the retail location promoting the reward 158, the configuration of the reward device 150 would need to be appropriate for the venue. For example, a rewards device 150 mounted at an outdoor gas pump and containing an expensive electronic device is probably not a secure situation. Also, a rewards device 150, including a flashing light 154 and sound device 155 that goes off when the customer wins, should probably not be mounted at an ATM, thereby alerting other customers, the public and possible criminal elements that the customer just won and now has in his or her possession an item of great worth.

Although the present invention has been described with respect to the above exemplary embodiments, various additions, deletions and modifications are contemplated as being within its scope.

What is claimed is:

1. An incentives system for providing instant tangible rewards at automated customer service devices as part of an incentives program, the system comprising:
a reward container located in proximity and operationally connected to an automated customer service device, the reward container including an enclosure housing and displaying a tangible reward, the reward container configured to dispense the tangible reward upon receiving a predetermined signal; and
an incentives network operationally coupled to the reward container and the automated customer service device, the incentives network generating the predetermined signal for the reward container based on specific predetermined criteria configured as part of the incentives program to achieve a desired outcome, the incentives network receiving data generated by the automated customer service device as input when analyzing the specific criteria,
such that when the data generated by the automated device having the reward container connected thereto results connected thereto in the specific criteria of the incentives network being met, the reward container dispenses the reward to a user.

2. The system of claim 1, wherein the reward container further comprises an alerting means configured to alert the user and others that the user has met the criteria to receive the reward.

3. The system of claim 2, wherein the alerting means consists of one of a light, a sound source and a light plus a sound source.

4. The system of claim 1, wherein the reward container is configured to open when dispensing the reward, such that the user may remove the reward from the reward container.

5. The system of claim 1, wherein the reward container is configured to eject the reward when dispensing the reward, such that the user receives the reward from the reward container.

6. The system of claim 1, wherein the reward container reloads automatically after the reward has been dispensed.

7. The system of claim 1, wherein the reward container is mounted to the automated device.

8. The system of claim 1, wherein the automated device consists of one of an automated teller machine, a ticket vending machine, a store self-checkout device and a self-service fuel pump.

9. The system of claim 1, wherein the automated customer service device is capable of being operated by both the user and an employee.

10. The system of claim 1, wherein the incentives network is configured to run on the World Wide Web with virtual connections to automated customer service devices and reward containers located in different companies and multiple locations through local networks and company networks as provided at each location.

11. A method of providing instant tangible rewards at automated devices as part of an incentives program, the method comprising:
providing a reward container located in proximity to an automated customer service device, the reward container including an enclosure housing and displaying a tangible reward, the reward container configured to dispense the tangible reward upon receiving a predetermined signal; and
providing an incentives network operationally coupled to the reward container and the automated customer service device, the incentives network
analyzing data from the automated customer service device using specific criteria setup to achieve a desired user activity defined by the incentives program,
generating the predetermined signal for the reward container when the data indicates that the user has achieved the desired user activity and thus is eligible to receive a reward, and
triggering the reward container to dispense the tangible reward to the user.

12. The method of claim 11, wherein the step of triggering further comprises activating an alerting means for alerting the user and others that the user has won the reward.

13. The method of claim 11, wherein the reward container reloads another reward automatically after a user has claimed the reward in the reward container.

14. The method of claim 11, further comprising highlighting the incentive reward by bringing attention to the enclosure housing the reward.

15. An incentives network for operating an incentives program including reward containers located at automated customer service devices for providing instant tangible rewards to users of the automated customer service devices, the incentives network comprising:
an operational connection to the reward containers;
an operational connection to the automated devices;
a system for analyzing data received from the automated device using specific criteria setup to achieve a desired outcome of the incentives program, generating the predetermined signal for the reward container when the data meets the necessary criteria to receive a reward, and triggering the reward container to dispense the tangible reward to the user at the automated customer service device.

16. The incentives network of claim 15, further comprising a host including the incentives program, the host determining the selection of reward recipients, the frequency of the rewards and type of the rewards.

17. The incentives network of claim 15, wherein the incentives network is configured to run on a local network with generally direct connections to the automated devices and reward containers at that location.

18. The incentives network of claim 15, wherein the incentives network is configured to run on a company network providing connections to automated customer service devices and reward containers located in multiple locations through a local network at each location.

19. The incentives network of claim 15, wherein the incentives network is configured to run on the World Wide Web with virtual connections to automated customer service devices and reward containers located in different companies and multiple locations through local networks and company networks as provided at each location.

20. The incentives network of claim 15, wherein an incentives program provider hosts and administers incentives networks for a plurality of different organizations each having unique criteria being applied to determine the distribution of rewards from reward containers at numerous automated customer service devices.
